(19) United States
(12) Patent Application Publication
(10) Pub. No.: US 2012/0006977 A1
(43) Pub. Date: Jan. 12, 2012

(54) OPTICAL AMPLIFIER AND LIGHT RECEIVING DEVICE

(75) Inventors: Norifumi SHUKUNAMI, Kawasaki (JP); Tatsuya Tsuzuki, Kawasaki (JP)

(73) Assignee: FUJITSU LIMITED, Kawasaki (JP)

(21) Appl. No.: 13/234,669

(22) Filed: Sep. 16, 2011

Related U.S. Application Data
(63) Continuation of application No. PCT/JP2009/056186, filed on Mar. 26, 2009.

(51) Int. Cl. H01J 43/00; H01S 3/10

(52) U.S. Cl. 250/214 LA; 359/337.1

(57) ABSTRACT

An optical amplifier includes an optical signal path that optically couples an input port and an output port, and transmits an optical signal input from the input port to the output port; an optical amplification medium that is arranged in the optical signal path, and amplifies the optical signal in a predetermined amplification wavelength band; and an optical filter that is arranged between the optical amplification medium and the output port in the optical signal path, flattens gain wavelength characteristics of the optical amplification medium in the amplification wavelength band, and attenuates amplified spontaneous emission (ASE) at a center of the amplification wavelength band more greatly than ASE at both sides of the amplification wavelength band among ASE that occurs in the optical amplification medium on the optical signal amplified by the optical amplification medium.

### CROSS-REFERENCE TO RELATED APPLICATION

This application is a continuation of International Application No. PCT/JP2009/056186, filed on Mar. 26, 2009, the entire contents of which are incorporated herein by reference.

### FIELD

The embodiments discussed herein are directed to an optical amplifier and a light receiving device.

### BACKGROUND

In an optical communication system, signal light transmitted from a transmitting device travels through an optical fiber serving as an optical signal path, and is received by a receiving device. In such an optical communication system, an optical amplifier that amplifies an optical signal directly without converting the optical signal electrically is widely used to compensate light loss in the optical fiber.

FIG. 11 is a diagram of an exemplary configuration of a typical optical communication system. As illustrated in FIG. 11, in an optical communication system 100, signal light transmitted from a light transmitting device 101 travels through an optical fiber 102 serving as an optical signal path, and is received by a light receiving device 103. The light receiving device 103 includes an optical amplifier 104 and a photoelectric converter 105. The light receiving device 103 amplifies an optical signal by the optical amplifier 104, and converts the optical signal thus amplified into an electrical signal by the photoelectric converter 105.

FIG. 12 is a diagram of an exemplary configuration of the conventional optical amplifier 104 included in the light receiving device 103 illustrated in FIG. 11. As illustrated in FIG. 12, the optical amplifier 104 includes a demultiplexer 107, a photodiode (PD) 108, an optical isolator 109, a multiplexer 110, an excitation laser diode (LD) 111, an optical amplification medium 112 formed of an erbium-doped fiber (EDF), an optical isolator 113, a demultiplexer 114, and a PD 115 in an optical signal path 106 that is an optical fiber optically coupling an input port 106a and an output port 106b.

An optical signal input from the input port 106a to the optical signal path 106 is received by the demultiplexer 107. The demultiplexer 107 branches the optical signal thus received into two, outputs one of them to the PD 108, and outputs the other to the multiplexer 110 via the optical isolator 109. The PD 108 is connected to a monitoring device not illustrated, and the optical signal input from the input port 106a is monitored by the monitoring device. The multiplexer 110 multiplexes the optical signal (signal light) from the optical isolator 109 and excitation light from the excitation LD 111, and outputs the optical signal thus multiplexed to the optical amplification medium 112. The optical amplification medium 112 amplifies the optical signal from the multiplexer 110 in a predetermined amplification wavelength band, and outputs the optical signal to the demultiplexer 114 via the optical isolator 113. The demultiplexer 114 branches the optical signal from the optical isolator 113 into two, outputs one of them to the PD 115, and outputs the other to the output port 106b. The PD 115 is connected to a monitoring device not illustrated, and the optical signal output from the output port 106b is monitored by the monitoring device.

The optical amplifier 104 has a problem in that amplified spontaneous emission (ASE), which is a noise component, occurs in association with the amplification of an optical signal in the optical amplification medium 112, thereby deteriorating the transmission quality.

FIG. 13 is a schematic of an example of an optical output spectrum in the optical amplifier 104. In the example of FIG. 13, the horizontal axis represents wavelengths (nm), and the vertical axis represents optical output (dBm).

As illustrated in FIG. 13, in the optical amplifier 104, if the optical amplification medium 112 amplifies an optical signal in an amplification wavelength band of 1525 nm to 1570 nm, ASE occurs in the amplification wavelength band. If power of the ASE is excessively large compared with power of signal light, the S/ASE ratio, which is a ratio of the ASE power to the signal light power, decreases. As a result, the transmission quality deteriorates. S/ASE (dB), which is a ratio of ASE power P₂ (mW) to signal light power P₁ (mW), is defined by following Equation.

S/ASE=10×log(P₁/P₂) (1)

Various types of optical amplifiers that prevent the problem described above from occurring have been developed. For example, Japanese Laid-open Patent Publication No. 04-113328, Japanese Laid-open Patent Publication No. 05-3356, and Japanese Laid-open Patent Publication No. 06-196788 disclose optical amplifiers in which an optical filter restricting an amplification wavelength band of an optical amplification medium in which ASE occurs, and transmitting signal light alone, such as a band pass filter (BPF), a long wavelength pass filter (LWPF), and a short wavelength pass filter (SWPF), is arranged on the output side of the optical amplification medium so as to prevent the S/ASE ratio from decreasing. Japanese Laid-open Patent Publication No. 11-242116 and Japanese Laid-open Patent Publication No. 11-317709 disclose optical amplifiers in which a tunable optical filter that performs variable control on a transmission wavelength band so as to selectively transmit signal light of a predetermined wavelength alone is arranged on the output side of the optical amplification medium. Furthermore, Japanese Laid-open Patent Publication No. 2000-13327 and Published Japanese translation of PCT Application No. 2002-510870 disclose optical amplifiers in which a gain-flattening filter flattening gain wavelength characteristics of the optical amplification medium in the amplification wavelength band, and eliminating the ASE outside of the amplification wavelength band is arranged on the output side of the optical amplification medium.

However, the conventional optical amplifiers described above have the following problems. Specifically, in the optical amplifiers disclosed in Japanese Laid-open Patent Publication No. 04-113328, Japanese Laid-open Patent Publication No. 05-3356, and Japanese Laid-open Patent Publication No. 06-196788, the amplification wavelength band of the optical amplification medium in which the ASE occurs is restricted by the optical filter such as a BPF, the full band of the amplification wavelength band of the optical amplification medium may not be used effectively.

In the optical amplifiers described in Japanese Laid-open Patent Publication No. 11-242116 and Japanese Laid-open Patent Publication No. 11-317709, the mechanism for selecting the transmission wavelength band in the tunable optical filter is made complicated, thereby increasing manufacturing costs.

In the optical amplifiers described in Japanese Laid-open Patent Publication No. 2000-13327 and Published Japanese translation of PCT Application No. 2002-510870, if the gain is constant, the gain-flattening filter can flatten the gain wavelength characteristics of the optical amplification medium in the amplification wavelength band. However, if the gain changes (for example, if power of the input optical signal is fixed, and power of the output optical signal changes), a gain tilt of the optical amplification medium occurs. As a result, the S/ASE ratio decreases problematically.

The decrease in the S/ASE ratio caused by the gain tilt of the optical amplification medium will now be described. FIGS. 14A to 14F are schematics of optical output spectra of the optical amplification medium when the gain-flattening filter is applied. In the example of FIGS. 14A to 14F, the horizontal axis represents wavelengths (nm), and the vertical axis represents optical output (dBm). In the example of FIGS. 14A to 14F, power of the input signal light is −20 dBm, and power of the output signal light is 15 dBm (gain is 35 dB). FIGS. 14A to 14F illustrate the optical output spectra when the signal wavelengths are 1528.8 nm, 1532.3 nm, 1538.2 nm, 1545.7 nm, 1557.8 nm, and 1563.5 nm, respectively.

As illustrated in FIGS. 14A to 14F, if the gain is 35 dB, the gain wavelength characteristics of the optical amplification medium in an amplification wavelength band from 1525 to 1565 nm are flattened by the gain-flattening filter, whereby the spectra of the ASE in the amplification wavelength band are flattened.

FIGS. 15A to 15F and 16A to 16F are schematics of optical output spectra of the optical amplification medium when a gain-flattening filter similar to that in FIGS. 14A to 14F is used. However, in the examples of FIGS. 15A to 15F and 16A to 16F, the power of the input signal light is −20 dBm, and the power of the output signal light are 20 dBm (gain is 40 dB) and 10 dBm (gain is 30 dB), respectively.

As illustrated in FIGS. 15A to 15F, if the power of the output signal light is 20 dBm (gain is 40 dB), in other words, if the gain is larger than gain of 35 dB flattened by the gain-flattening filter, the spectrum of the ASE on the short wavelength side is larger than the spectrum on the long wavelength side, whereby a downward-sloping gain tilt occurs. As illustrated in FIG. 15F, when the signal light is present on the long wavelength side, the spectrum of the ASE on the short wavelength side is the maximum. As a result, the S/ASE ratio decreases compared with the case where the power of the output signal light is 15 dBm (gain is 35 dB) (refer to FIG. 14F).

By contrast, as illustrated in FIGS. 16A to 16F, if the power of the output signal light is 10 dBm (gain is 30 dB), in other words, if the gain is smaller than gain of 35 dB flattened by the gain-flattening filter, the spectrum of the ASE on the long wavelength side is larger than the spectrum on the short wavelength side, whereby an upward-sloping gain tilt occurs. As illustrated in FIG. 16A, when the signal light is present on the short wavelength side, the spectrum of the ASE on the long wavelength side is the maximum. As a result, the S/ASE ratio decreases compared with the case where the power of the output signal light is 15 dBm (gain is 35 dB) (refer to FIG. 14A).

FIG. 17 is a schematic of a relationship between the wavelength of the optical signal and the S/ASE ratio when the power of the output signal light changes. In the example of FIG. 17, the horizontal axis represents wavelengths (nm) of the optical signal, and the vertical axis represents S/ASE (dB). As illustrated in FIG. 17, if power Pin of the input signal light is fixed at −20 dBm, and power Pout of the output signal light changes from 10 dBm to 20 dBm, that is, if the gain changes from 30 to 40 dB, while the S/ASE ratio in the center of the wavelength band does not change, the S/ASE ratios on both sides of the wavelength band decrease down to 4.8 dB.

As described above, in the optical amplifier in which the gain-flattening filter is arranged on the output side of the optical amplification medium, if the power of the input optical signal is fixed, and the power of the output signal light changes, that is, if the gain changes, a gain tilt of the optical amplification medium occurs. As a result, the S/ASE ratios on both sides of the wavelength band decrease.

### SUMMARY

According to an aspect of an embodiment of the invention, an optical amplifier that amplifies an optical signal input from an input port, and outputs the optical signal from an output port, includes an optical signal path that optically couples the input port and the output port, and transmits the optical signal input from the input port to the output port; an optical amplification medium that is arranged in the optical signal path, and amplifies the optical signal in a predetermined amplification wavelength band; and an optical filter that is arranged between the optical amplification medium and the output port in the optical signal path, flattens gain wavelength characteristics of the optical amplification medium in the amplification wavelength band, and attenuates amplified spontaneous emission (ASE) at a center of the amplification wavelength band more greatly than ASE at both sides of the amplification wavelength band among ASE that occurs in the optical amplification medium on the optical signal amplified by the optical amplification medium.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a block diagram of a configuration of a light receiving device including an optical amplifier according to a first embodiment;

FIG. 2 is a block diagram of a configuration of the optical amplifier illustrated in FIG. 1;

FIG. 3 is a conceptual schematic for explaining filter characteristics of an optical filter;

FIG. 4 is a schematic illustrating a state in which a spectral shape of ASE illustrated in FIG. 15F and a spectral shape of ASE illustrated in FIG. 16A are superimposed;

FIG. 5 is a schematic of second filter characteristics of the optical filter that attenuates ASE present in a common portion between the spectral shapes illustrated in FIG. 4;

FIG. 6 is a schematic of first filter characteristics of the optical filter that flattens gain wavelength characteristics of the optical amplification medium in an amplification wavelength band;

FIG. 7 is a schematic of filter characteristics of the optical filter;

FIG. 8 is a schematic of a relationship between a wavelength of an optical signal and the S/ASE ratio when power of output signal light changes;

FIG. 9 is a block diagram of a configuration of an optical amplifier according to a second embodiment;

FIG. 10 is a block diagram of a modification of the light receiving device;

FIG. 11 is a diagram of an exemplary configuration of a typical optical communication system;

FIG. 12 is a diagram of an exemplary configuration of a conventional optical amplifier included in the receiving device illustrated in FIG. 11;

FIG. 13 is a schematic of an example of an optical output spectrum in the optical amplifier;

FIGS. 14A to 14F are schematics of optical output spectra of the optical amplification medium when a gain-flattening filter is applied;

FIGS. 15A to 15F are schematics of optical output spectra of the optical amplification medium when a gain-flattening filter similar to that in FIGS. 14A to 14F is used;

FIGS. 16A to 16F are schematics of optical output spectra of the optical amplification medium when the gain-flattening filter similar to that in FIGS. 14A to 14F is used; and

FIG. 17 is a schematic of a relationship between a wavelength of an optical signal and the S/ASE ratio when power of output signal light changes.

### DESCRIPTION OF EMBODIMENTS

Preferred embodiments of the present invention will be explained with reference to accompanying drawings.

### [a] First Embodiment

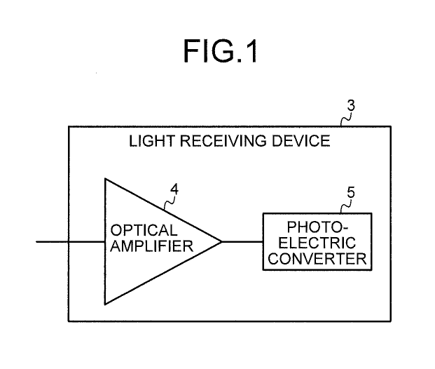

FIG. 1 is a block diagram of a configuration of a light receiving device including an optical amplifier according to the present embodiment. As illustrated in FIG. 1, a light receiving device 3 includes an optical amplifier 4 that amplifies an optical signal input from an input port, and outputs the optical signal thus amplified from an output port, and a photoelectric converter 5 that converts the optical signal output from the optical amplifier 4 into an electrical signal.

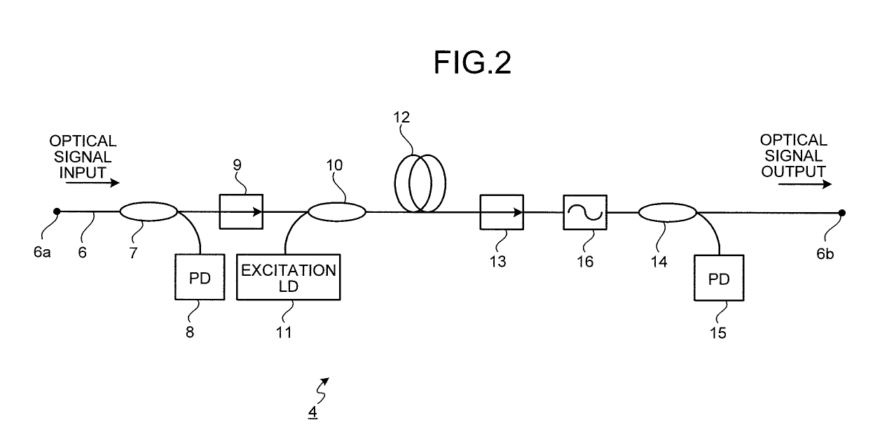

FIG. 2 is a block diagram of a configuration of the optical amplifier 4 illustrated in FIG. 1. As illustrated in FIG. 2, the optical amplifier 4 includes an optical signal path 6, a demultiplexer 7, a photodiode (PD) 8, an optical isolator 9, a multiplexer 10, an excitation laser diode (LD) 11, an optical amplification medium 12, an optical isolator 13, a demultiplexer 14, a PD 15, and an optical filter 16.

The optical signal path 6 is a signal path that optically couples an input port 6a and an output port 6b, and that transmits an optical signal input from the input port 6a to the output port 6b. The optical signal path 6 is formed of an optical fiber for transmitting optical signals.

The demultiplexer 7 branches the optical signal received by the optical signal path 6 from the input port 6a into two, outputs one of them to the PD 8, and outputs the other to the multiplexer 10 via the optical isolator 9. The PD 8 is connected to a monitoring device not illustrated, and receives the optical signal branched by the demultiplexer 7, whereby the optical signal input from the input port 6a is monitored by the monitoring device.

The optical isolator 9 and the optical isolator 13 transmits the optical signal traveling in the direction from the input port 6a to the output port 6b, and blocks the optical signal traveling in the direction from the output port 6b to the input port 6a. The multiplexer 10 multiplexes the optical signal (signal light) from the optical isolator 9 and excitation light from the excitation LD 11, and outputs the optical signal thus multiplexed to the optical amplification medium 12. The excitation LD 11 generates excitation light that excites the optical amplification medium 12.

The optical amplification medium 12 is arranged in the optical signal path 6, and amplifies the optical signal in a predetermined amplification wavelength band. For the medium constituting the optical amplification medium 12, any medium may be used as far as the medium is likely to obtain relatively high gain. In the present embodiment, a silica-based erbium-doped optical fiber is used.

The demultiplexer 14 branches the optical signal from the optical amplification medium 12 into two, outputs one of them to the PD 15, and outputs the other to the output port 6b. The PD 15 is connected to a monitoring device not illustrated, and receives the optical signal branched by the demultiplexer 14, whereby the optical signal output from the output port 6b is monitored by the monitoring device.

The optical filter 16 is a filter such as a dielectric multilayer arranged between the optical amplification medium 12 and the output port 6b in the optical signal path 6. The optical filter 16 flattens gain wavelength characteristics of the optical amplification medium 12 in the amplification wavelength band, and performs filter processing for attenuating amplified spontaneous emission (ASE) present in the center of the amplification wavelength band more greatly than ASE present on both sides of the amplification wavelength band among the ASE that occurs in the optical amplification medium 12 on the optical signal amplified by the optical amplification medium 12.

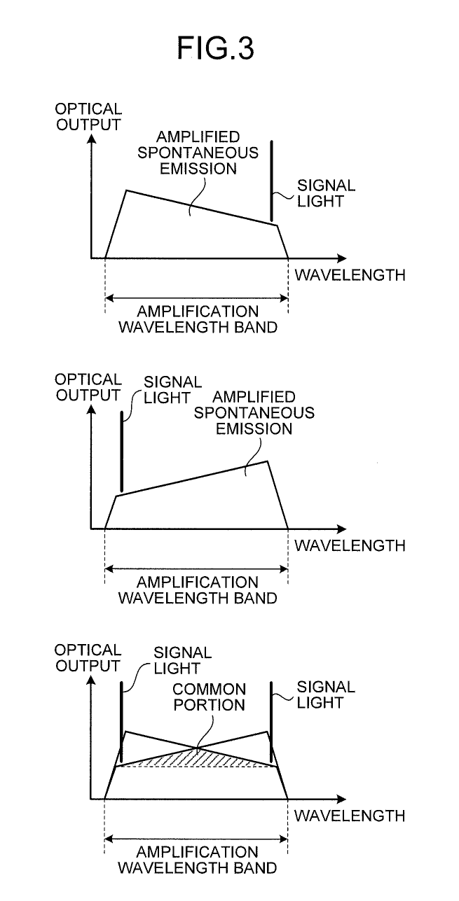

Filter characteristics of the optical filter 16 for performing the filter processing described above will now be described with reference to FIGS. 3 to 7. FIG. 3 is a conceptual schematic for explaining the filter characteristics of the optical filter 16.

The optical filter 16 has the filter characteristics obtained by combining first filter characteristics and second filter characteristics. The first filter characteristics are filter characteristics that flatten the gain wavelength characteristics of the optical amplification medium 12 in the amplification wavelength band. The second filter characteristics are filter characteristics that attenuate the ASE present in the center of the amplification wavelength band more greatly than the ASE present on both sides of the amplification wavelength band among the ASE that occurs in the optical amplification medium 12.

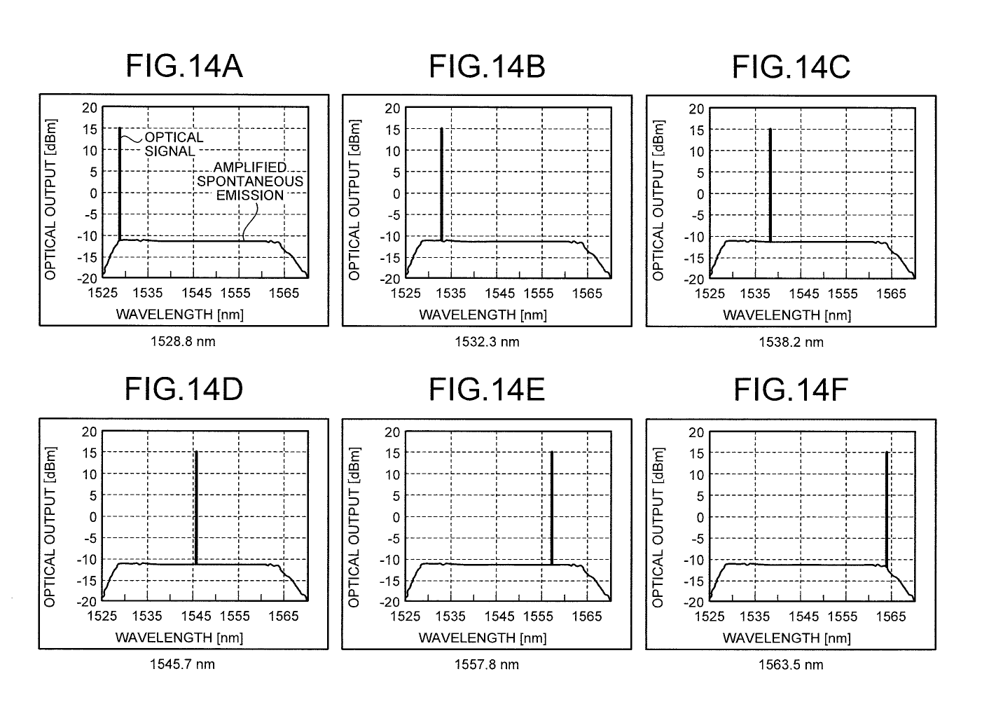

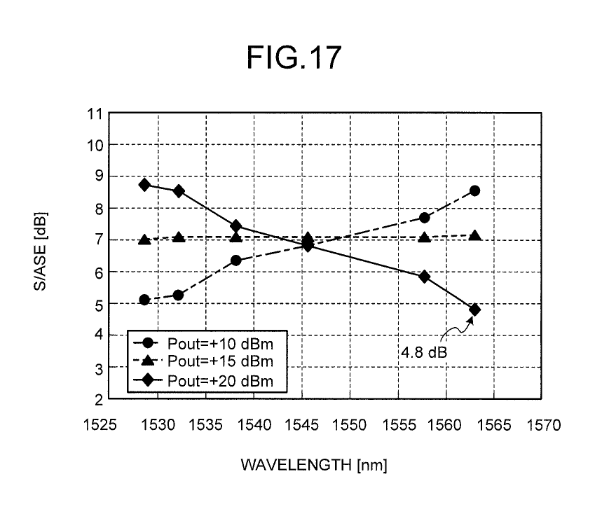

Assuming that the optical filter 16 has the first filter characteristics alone, and does not have the second filter characteristics, if the gain in the optical amplifier 4 changes, the gain tilt of the optical amplification medium 12 occurs as explained with reference to FIGS. 14A to 16F. In other words, if the gain is larger than the gain flattened by the first filter characteristics of the optical filter 16, and the signal light is present on the long wavelength side of the amplification wavelength band, a gain tilt in which the spectrum of the ASE on the short wavelength side is the maximum occurs as illustrated on the upper part of FIG. 3. By contrast, if the gain is smaller than the gain flattened by the first filter characteristics of the optical filter 16, and the signal light is present on the short wavelength side of the amplification wavelength band, a gain tilt in which the spectrum of the ASE on the long wavelength side is the maximum occurs as illustrated in the center of FIG. 3. As a result, S/ASE ratios on both sides of the amplification wavelength band decrease (refer to FIG. 17). However, the S/ASE ratio in the center of the amplification wavelength band hardly changes.

Therefore, in order to suppress the decrease in the S/ASE ratios on both sides of the amplification wavelength band, the optical filter 16 according to the present embodiment has the second filter characteristics that attenuate the ASE in the center of the amplification wavelength band whose S/ASE ratio hardly changes even if the gain changes together with the first filter characteristics.

Specifically, as illustrated on the lower part of FIG. 3, the optical filter 16 attenuates the ASE present in a common portion between the spectral shape of the ASE (refer to the upper part of FIG. 3) when the gain is larger than the gain flattened by the first filter characteristics of the optical filter 16, and when the signal light is present on the long wavelength side of the amplification wavelength band, and the spectral shape of the ASE (refer to the center of FIG. 3) when the gain is smaller than the gain flattened by the first filter characteristics of the optical filter 16, and when the signal light is present on the short wavelength side of the amplification wavelength band by the second filter characteristics.

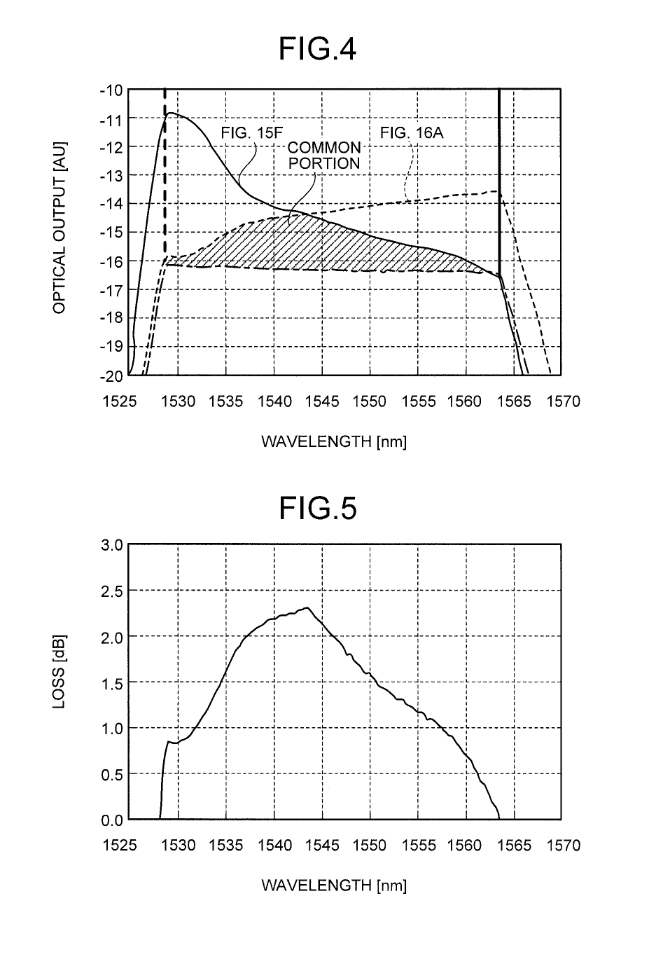

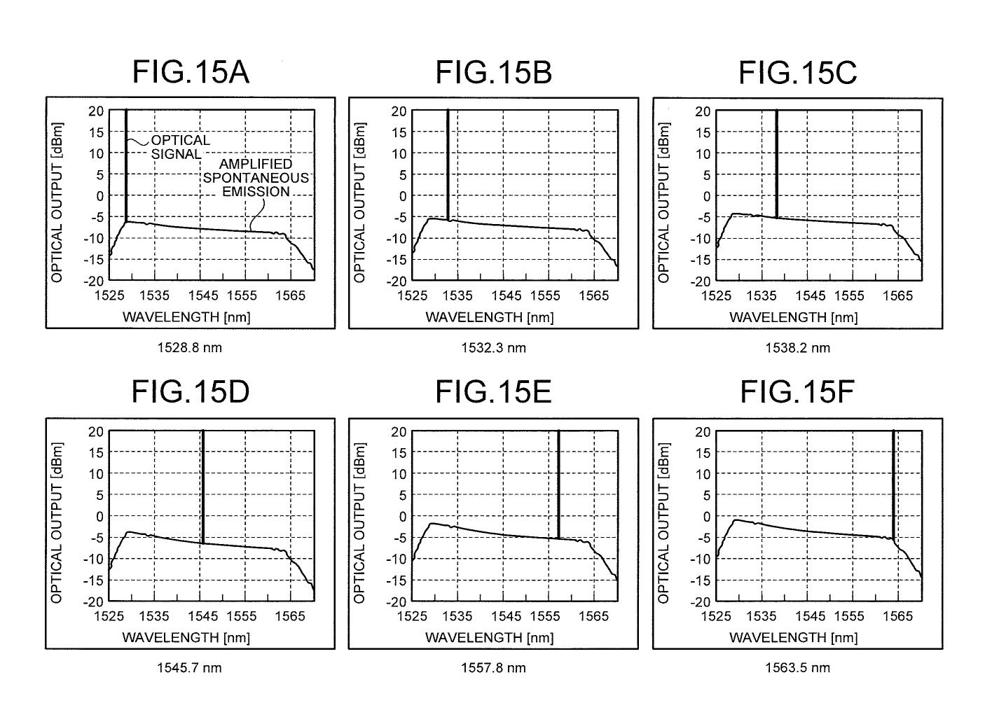

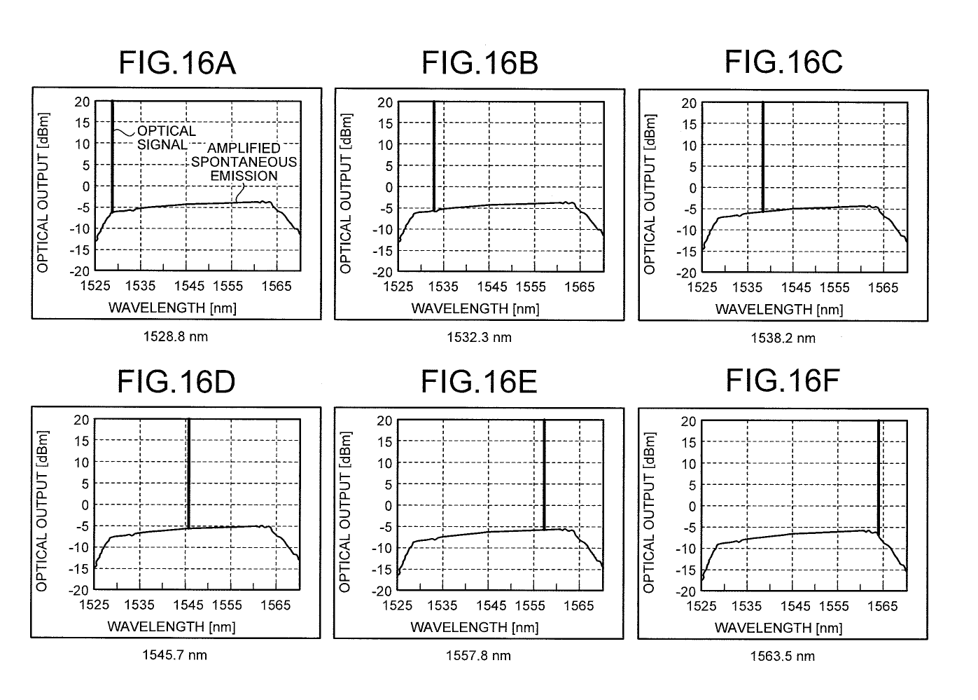

FIG. 4 is a schematic illustrating a state in which the spectral shape of the ASE illustrated in FIG. 15F and the spectral shape of the ASE illustrated in FIG. 16A are superimposed. The spectral shapes of the ASE illustrated in FIGS. 15F and 16A correspond to the spectral shapes of the ASE illustrated on the upper part of FIG. 3 and in the center of FIG. 3, respectively. In the example of FIG. 4, the horizontal axis represents wavelengths (nm), and the vertical axis represents optical output (AU). As illustrated in FIG. 4, the optical filter 16 attenuates the ASE present in the common portion between the spectral shape of the ASE illustrated in FIG. 15F, and the spectral shape of the ASE illustrated in FIG. 16A by the second filter characteristics.

FIG. 5 is a schematic of the second filter characteristics of the optical filter 16 that attenuates the ASE present in the common portion between the spectral shapes illustrated in FIG. 4. In the example of FIG. 5, the horizontal axis represents wavelengths (nm), and the vertical axis represents loss (dB). As illustrated in FIG. 5, in the second filter characteristic of the optical filter 16, loss in the center of the amplification wavelength band is larger than loss on the both sides of the amplification wavelength band so as to attenuate the ASE present in the center of the amplification wavelength band more greatly than the ASE present on both sides of the amplification wavelength band among the ASE that occurs in the optical amplification medium 12.

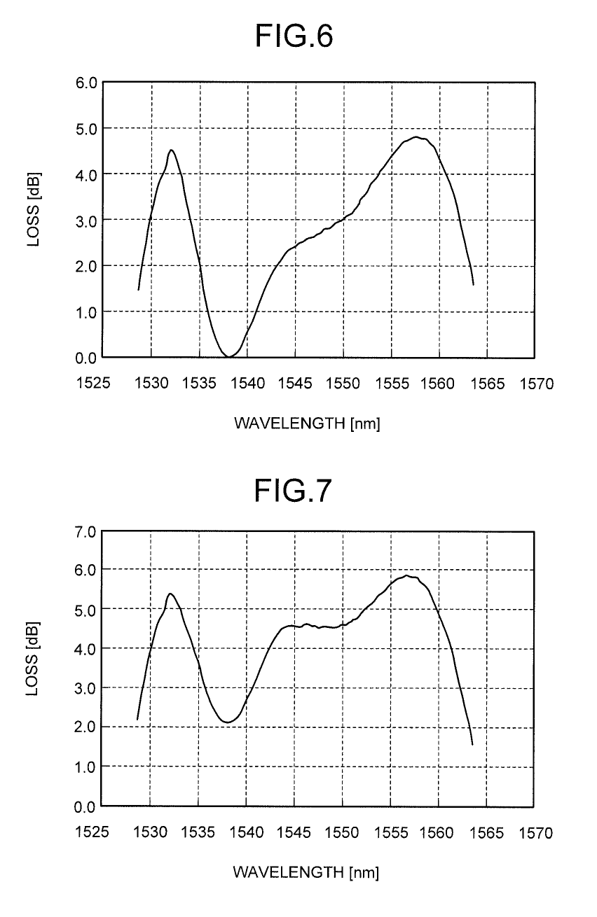

FIG. 6 is a schematic of the first filter characteristics of the optical filter 16 that flattens the gain wavelength characteristics of the optical amplification medium 12 in the amplification wavelength band. In the example of FIG. 6, the horizontal axis represents wavelengths (nm), and the vertical axis represents loss (dB).

The optical filter 16 according to the present embodiment has the filter characteristics obtained by combining the first filter characteristics illustrated in FIG. 6 and the second filter characteristics illustrated in FIG. 5. FIG. 7 illustrates the filter characteristics of the optical filter 16.

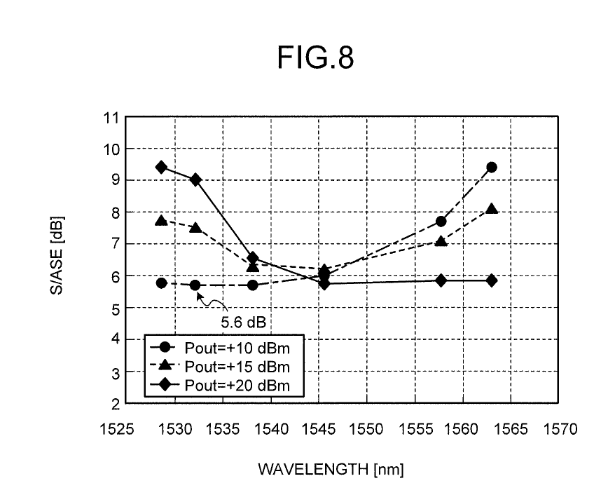

Advantageous effects of the optical amplifier 4 according to the present embodiment will now be described. FIG. 8 is a schematic of a relationship between a wavelength of the optical signal and the S/ASE ratio when the power of the output signal light changes. In the example of FIG. 8, the horizontal axis represents wavelengths (nm) of the optical signal, and the vertical axis represents S/ASE (dB). As illustrated in FIG. 8, in the optical amplifier 4 according to the present embodiment, if the power Pin of the input signal light is fixed at −20 dBm, and the power Pout of the output signal light changes from 10 dBm to 20 dBm, that is, if the gain changes from 30 to 40 dB, the S/ASE ratios on both sides of the amplification wavelength band of the optical amplification medium 12 decrease down to 5.6 dB. By contrast, in the conventional optical amplifier 104, the S/ASE ratios on both sides of the amplification wavelength band of the optical amplification medium decrease down to 4.8 dB as explained with reference to FIG. 17. From this result, it is found that the optical amplifier 4 according to the present embodiment includes the optical filter 16, thereby making it possible to suppress the decrease in the S/ASE ratio compared with the optical amplifier including the conventional gain-flattening filter, even if a gain tilt occurs.

As described above, in the optical amplifier 4 according to the present embodiment, the optical filter 16 flattens the gain wavelength characteristics of the optical amplification medium 12 in the amplification band, and performs the filter processing for attenuating the ASE present in the center of the amplification wavelength band more greatly than the ASE present on both sides of the amplification wavelength band among the ASE that occurs in the optical amplification medium 12 on the optical signal amplified by the optical amplification medium 12. Therefore, it is possible to use the full band of the amplification wavelength band effectively without restricting the amplification wavelength band of the optical amplification medium as in the conventional technology. In addition, the filter characteristics of the optical filter 16 can be realized simply by combining the first filter characteristics and the second filter characteristics, thereby making the configuration simple. Furthermore, because the filter characteristics of the optical filter 16 flatten the gain wavelength characteristics of the optical amplification medium 12 in the amplification band and attenuate the ASE present in the center of the amplification wavelength band, it is possible to suppress the decrease in the S/ASE ratio even if the gain tilt occurs.

### [b] Second Embodiment

A configuration of an optical amplifier according to a second embodiment will now be described. In the first embodiment, the explanation is made of the case where one optical amplification medium 12 is provided, and the optical signal is amplified by the optical amplification medium 12 only once. However, a plurality of optical amplification media may be provided, and an optical signal may be amplified by the plurality of optical amplification media more than once. In the second embodiment, an optical amplifier including two optical amplification media will be described.

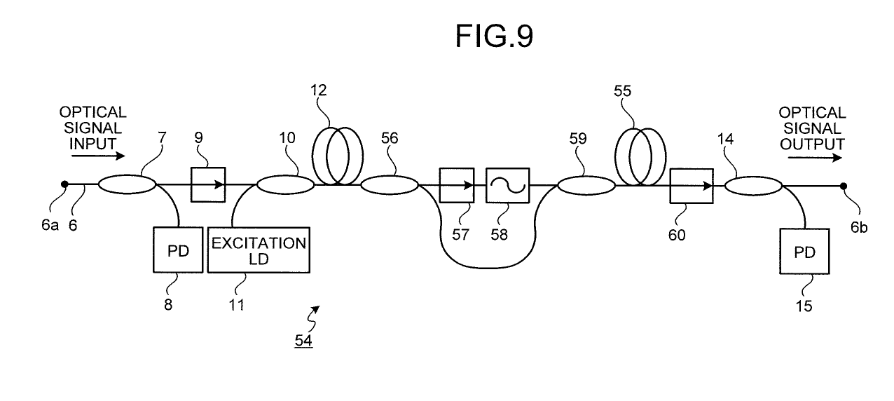

FIG. 9 is a block diagram of a configuration of an optical amplifier 54 according to the second embodiment. Components having functions similar to those of the components illustrated in FIG. 2 are denoted by like reference numerals, and the detailed description thereof will be omitted. As illustrated in FIG. 9, the optical amplifier 54 includes an optical amplification medium 55, a demultiplexer 56, an optical isolator 57, an optical filter 58, a multiplexer 59, and an optical isolator 60, instead of the optical isolator 13 and the optical filter 16 included in the optical amplifier 4 illustrated in FIG. 2.

The optical amplification medium 55 is a second optical amplification medium arranged independently from the optical amplification medium 12 between the optical amplification medium 12 serving as the first optical amplification medium and the output port 6b in the optical signal path 6. The demultiplexer 56 is a device that is arranged between the optical amplification medium 12 and the optical amplification medium 55 in the optical signal path 6, and that branches an optical signal amplified by the optical amplification medium 12.

The optical isolator 57 and the optical isolator 60 are devices that transmit the optical signal traveling in the direction from the input port 6a to the output port 6b, and that block the optical signal traveling in the direction from the output port 6b to the input port 6a.

The optical filter 58 is arranged between the demultiplexer 56 and the optical amplification medium 55 in the optical signal path 6. The optical filter 58 is a filter that flattens the gain wavelength characteristics of the optical amplification medium 12 in the amplification wavelength band, and that performs the filter processing for attenuating the ASE present in the center of the amplification wavelength band more greatly than the ASE present on both sides of the amplification wavelength band among the ASE that occurs in the optical amplification medium 12 on one of branched signals among the optical signals branched by the demultiplexer 56. The optical filter 58 has filter characteristics similar to those of the optical filter 16 illustrated in FIG. 2.

The multiplexer 59 synthesizes one of the branched signals on which the optical filter 58 performs the filter processing, and the other of the branched signals among the optical signals branched by the demultiplexer 56, and outputs the synthesized signal to the optical amplification medium 55.

The optical signal on which the optical filter 58 performs the filter processing has some optical loss through the optical filter 58. If the optical signal amplified by the optical amplification medium 12 passes through the optical filter 58, and is output to the optical amplification medium 55 directly, the optical amplification medium 55 amplifies the optical signal that has the optical loss caused by the optical filter 58. As a result, the transmittance quality deteriorates.

To prevent such deterioration in the transmittance quality, in the optical amplifier 54 according to the present embodiment, the demultiplexer 56 branches the optical signal amplified by the optical amplification medium 12. After the optical filter 58 performs the filter processing on one of the branched signals, the multiplexer 59 synthesizes one of the branched signals and the other of the branched signals. One of the branched signals on which the optical filter 58 performs the filter processing is synthesized with the other of the branched signals to be excited again. This makes it possible to compensate the optical loss caused by the optical filter 58, thereby allowing the optical amplification medium 55 to amplify the optical signal in a favorable state with little optical loss synthesized by the multiplexer 59. Therefore, the transmittance quality can be improved remarkably compared with the case where the optical signal amplified by the optical amplification medium 12 is output to the optical amplification medium 55 directly through the optical filter 58.

As described above, in the optical amplifier 54 according to the present embodiment, the optical filter 58 has the filter characteristics similar to those of the optical filter 16 according to the first embodiment. Therefore, it is possible to use the full band of the amplification wavelength band effectively without restricting the amplification wavelength band of the optical amplification medium as in the conventional technology. In addition, the configuration thereof can be simplified compared with the conventional tunable optical filter. Furthermore, because the filter characteristics of the optical filter 58 flatten the gain wavelength characteristics of the optical amplification medium 12 in the amplification band and attenuate the ASE present in the center of the amplification wavelength band, it is possible to suppress the decrease in the S/ASE ratio even if the gain tilt occurs. Moreover, the multiplexer 59 synthesizes one of the branched signals on which the optical filter 58 performs the filter processing, and the other of the branched signals branched by the demultiplexer 56, and outputs the synthesized signal to the optical amplification medium 55. This allows the optical amplification medium 55 to amplify the optical signal in a favorable state with little optical loss.

The embodiments according to the present invention are explained above. The present invention, however, may be applied to various alternative embodiments within the spirit and scope of the technological concept disclosed in the claims in addition to the embodiments described above.

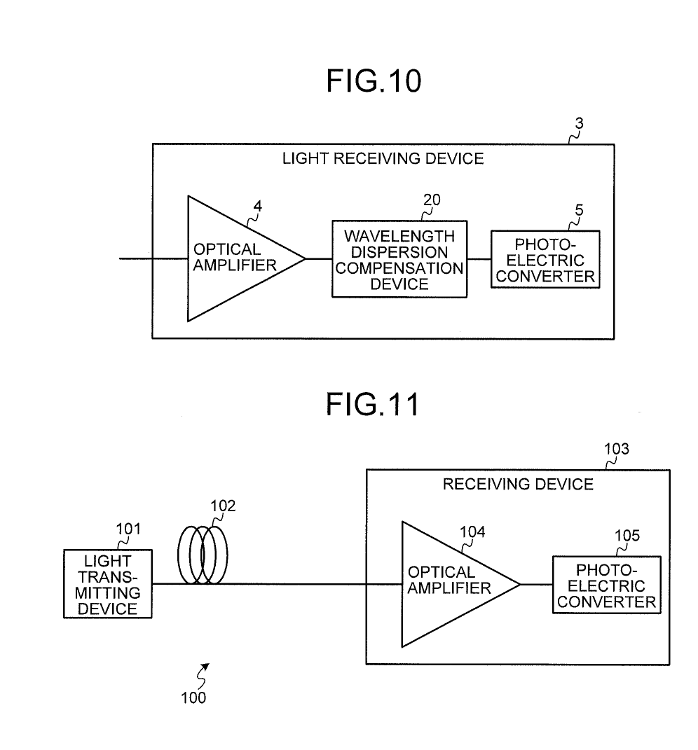

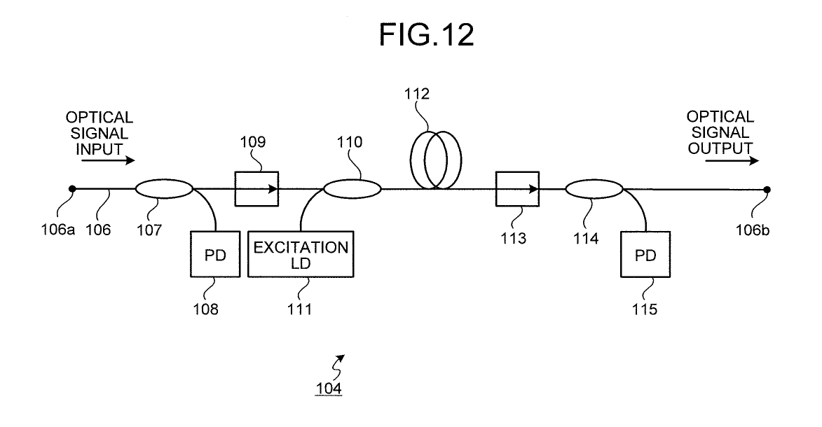

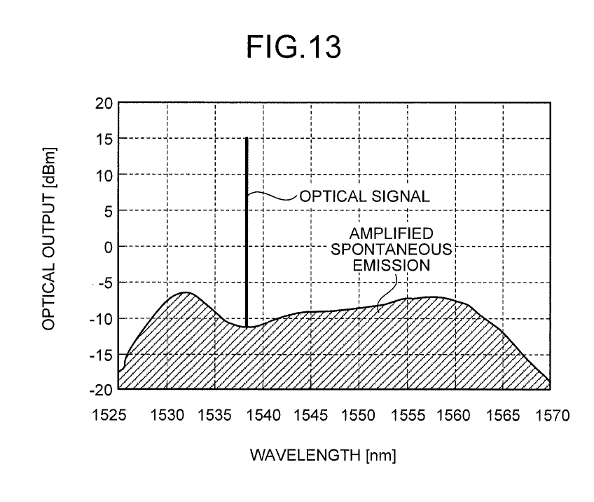

For example, in the light receiving device 3 according to the first and the second embodiments, the photoelectric converter 5 is arranged just after the optical amplifier 4 (or the optical amplifier 54). However, the configuration is not limited thereto, and a wavelength dispersion compensation device 20 that compensates wavelength dispersion of the optical signal may be arranged between the optical amplifier 4 (or the optical amplifier 54) and the photoelectric converter 5 as illustrated in FIG. 10.

Furthermore, in the optical amplifiers 4, 54 according to the first and the second embodiments, one optical filter 16 (or one optical filter 58) has the filter characteristics obtained by combining the first filter characteristics that flatten the gain wavelength characteristics of the optical amplification medium 12 in the amplification wavelength band, and the second filter characteristics that attenuate the ASE present in the center of the amplification wavelength band more greatly than the ASE present on both sides of the amplification wavelength band among the ASE that occurs in the optical amplification medium 12. However, the configuration is not limited thereto, and an optical filter having the first filter characteristics and an optical filter having the second filter characteristics may be prepared independently from each other, and these two optical filters may be connected.

It is possible to suppress a decrease in the S/ASE ratio while using an amplification wavelength band of an optical amplification medium effectively in a simple configuration.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical amplifier that amplifies an optical signal input from an input port, and outputs the optical signal from an output port, the optical amplifier comprising:
an optical signal path that optically couples the input port and the output port, and transmits the optical signal input from the input port to the output port;
an optical amplification medium that is arranged in the optical signal path, and amplifies the optical signal in a predetermined amplification wavelength band; and
an optical filter that is arranged between the optical amplification medium and the output port in the optical signal path, flattens gain wavelength characteristics of the optical amplification medium in the amplification wavelength band, and attenuates amplified spontaneous emission (ASE) at a center of the amplification wavelength band more greatly than ASE at both sides of the amplification wavelength band among ASE that occurs in the optical amplification medium on the optical signal amplified by the optical amplification medium.

2. The optical amplifier according to claim 1, wherein the optical amplification medium is an erbium-doped optical fiber.

3. An optical amplifier that amplifies an optical signal input from an input port, and outputs the optical signal from an output port, the optical amplifier comprising:
an optical signal path that optically couples the input port and the output port, and transmits the optical signal input from the input port to the output port;
a first optical amplification medium that is arranged in the optical signal path, and amplifies the optical signal in a predetermined amplification wavelength band;
a second optical amplification medium arranged independently from the first optical amplification medium between the first optical amplification medium and the output port in the optical signal path; and
an optical filter that is arranged between the first optical amplification medium and the second optical amplification medium in the optical signal path, flattens gain wavelength characteristics of the first optical amplification medium in the amplification wavelength band, and attenuates amplified spontaneous emission (ASE) at a center of the amplification wavelength band more greatly than ASE at both sides of the amplification wavelength band among ASE that occurs in the first optical amplification medium on the optical signal amplified by the first optical amplification medium.

4. A light receiving device comprising:
an optical amplifier that amplifies an optical signal input from an input port, and outputs the optical signal from an output port; and
a photoelectric converter that converts the optical signal output by the optical amplifier into an electrical signal, wherein
the optical amplifier comprises:
an optical signal path that optically couples the input port and the output port, and transmits the optical signal input from the input port to the output port;
an optical amplification medium that is arranged in the optical signal path, and amplifies the optical signal in a predetermined amplification wavelength band; and
an optical filter that is arranged between the optical amplification medium and the output port in the optical signal path, flattens gain wavelength characteristics of the optical amplification medium in the amplification wavelength band, and attenuates amplified spontaneous emission (ASE) at a center of the amplification wavelength band more greatly than ASE at both sides of the amplification wavelength band among ASE that occurs in the optical amplification medium on the optical signal amplified by the optical amplification medium.
